(19) United States
(12) Patent Application Publication
(10) Pub. No.: US 2013/0258328 A1
(43) Pub. Date: Oct. 3, 2013

(54) DISK SURFACE INSPECTION METHOD AND DISK SURFACE INSPECTION DEVICE

(71) Applicant: HITACHI HIGH-TECHNOLOGIES CORPORATION, Tokyo (JP)

(72) Inventors: Nobuyuki SUGIMOTO, Kamisato-machi (JP); Shigeru SERIKAWA, Kamisato-machi (JP); Yu YANAKA, Kamisato-machi (JP); Kiyotaka HORIE, Kamisato-machi (JP)

(73) Assignee: HITACHI HIGH-TECHNOLOGIES CORPORATION, Tokyo (JP)

(21) Appl. No.: 13/761,625

(22) Filed: Feb. 7, 2013

(30) Foreign Application Priority Data
Mar. 29, 2012 (JP) 2012-076837

(51) Int. Cl. G01N 21/88

(52) U.S. Cl. CPC G01N 21/88
USPC 356/237.2

(57) ABSTRACT

Provided is a disk surface inspection device that makes it possible to extract defects repeatedly occurring at a particular position on the disk surface. The disk surface inspection device comprises conveyance means which extracts a disk from a cassette and conveys the disk, table means including a spindle which rotates the disk mounted thereon while moving the disk in a direction and a rotation angle detecting unit which detects the rotation angle of the spindle, optical detection means which irradiates the disk with light and detects reflected light from the disk, signal processing means which detects defects by processing a detection signal from the optical detection means, and output means. The signal processing means stores positional information of defects detected on the disk by use of rotation angle information on the spindle and positional information on a particular part of the disk stored in the cassette.

### BACKGROUND OF THE INVENTION

The present invention relates to a disk surface inspection method and a disk surface inspection device for inspecting surfaces of disks such as magnetic disks and optical disks and thereby detecting defects such as scratches.

A technique for inspecting defects (e.g., scratches) on a surface of a magnetic disk has been described in JP-A-2011-122998 (hereinafter referred to as “Patent Literature 1”), for example. In this technique, the defects are detected by setting a large number of counting track regions throughout the surface of the magnetic disk. Specifically, for the large number of counting track regions which have been set, histogram data of the number of detected defects (defect count histogram data) is generated for each of counting track region groups differing in the radius. From the counting track region groups corresponding to various radii (various radius ranges), groups whose defect count histogram data exceeds a standard deviation value (threshold deviation value) are selected, and the detection of circumferential scratches is carried out for the selected counting track region groups. Alternatively, for the large number of counting track regions which have been set, the defect count histogram data is generated for each of counting track region groups differing in the angle. From the counting track region groups corresponding to various angles (various angle ranges), groups whose defect count histogram data exceeds a standard deviation value (threshold deviation value) are selected, and the detection of island-like defects is carried out for the selected counting track region groups. The patent literature describes that the technique is capable of lightening the processing load on the data processing device even when the number of detected defects increases since the defect detection process can be executed step by step by separating the circumferential scratches or the island-like defects from other types of defects.

### SUMMARY OF THE INVENTION

The washing process can be named as one of the causes of the defects occurring on surfaces of disks such as magnetic disks and optical disks. The defects occurring in the washing process have a characteristic in that they occur repeatedly in a particular part of the disk surface. Therefore, in order to spot the defects that occurred in the washing process, it becomes necessary to extract such defects repeatedly occurring at a particular position on a plurality of disk surfaces by inspecting disk surfaces after undergoing the washing process and stacking up (superimposing together) the inspection results of a plurality of disks.

However, although the invention described in the Patent Literature 1 enables comparison of the defect data among a plurality of magnetic disks by determining the position of each defect on the magnetic disk (inspection target) in the radial direction, the invention has not considered the determination of the position of each defect in the angular direction (circumferential direction).

The present invention provides a disk surface inspection method and a disk surface inspection device that make it possible to extract defects repeatedly occurring at a particular position on the disk surface by determining the position of each detected defect in the radial direction and in the angular direction (circumferential direction) in the defect detection on the disk surface and stacking up (superimposing together) the inspection results of a plurality of disks.

In order to resolve the above problem, a disk surface inspection device in accordance with an aspect of the present invention comprises: conveyance means which extracts a disk from a cassette and conveys the disk; table means including a spindle on which the disk conveyed by the conveyance means is mounted, a rotary driving unit which drives and rotates the spindle, a rotation angle detecting unit which detects the rotation angle of the spindle, and a linear driving unit which drives the spindle in an axial direction; optical detection means including a light irradiation unit which irradiates the disk mounted on the spindle with light and a condensation/detection unit which condenses and detects reflected light from the disk irradiated with the light from the light irradiation unit; signal processing means which detects defects on the disk by processing a signal from the optical detection means condensing and detecting the reflected light from the disk; and output means which outputs the result of the processing by the signal processing means. The signal processing means stores the position of each of the detected defects after converting the position into positional information with reference to the position of a particular part of the disk by use of rotation angle information on the spindle outputted by the rotation angle detecting unit of the table means and positional information on a particular part of the disk stored in the cassette.

In order to resolve the above problem, a disk surface inspection device in accordance with another aspect of the present invention comprises: first conveyance means which extracts a disk from a cassette and conveys the disk; first table means including a first spindle on which the disk conveyed by the first conveyance means is mounted, a rotary driving unit which drives and rotates the first spindle, a first rotation angle detecting unit which detects the rotation angle of the first spindle, and a first linear driving unit which drives the first spindle in an axial direction; second conveyance means which removes the disk from the first spindle, inverts the disk, and conveys the inverted disk; second table means including a second spindle on which the inverted disk conveyed by the second conveyance means is mounted, a rotary driving unit which drives and rotates the second spindle, a second rotation angle detecting unit which detects the rotation angle of the second spindle, and a second linear driving unit which drives the second spindle in an axial direction; optical detection means including a light irradiation unit which irradiates the disk mounted on the first spindle or the second spindle with light and a condensation/detection unit which condenses and detects reflected light from the disk irradiated with the light from the light irradiation unit; signal processing means which detects defects on the disk by processing a signal from the optical detection means which condenses and detects the reflected light from the disk; and output means which outputs the result of the processing by the signal processing means. The signal processing means stores the position of each of the defects detected on the disk mounted on the first spindle after converting the position into positional information with reference to the position of a particular part of the disk by use of rotation angle information on the first spindle outputted by the first rotation angle detecting unit of the first table means and positional information on a particular part of the disk stored in the cassette. The signal processing means stores the position of each of the defects detected on the inverted disk mounted on the second spindle after converting the position into positional information with reference to the position of a particular part of the disk by use of rotation angle information on the second spindle outputted by the second rotation angle detecting unit of the second table means and positional information on a particular part of the disk just before being removed from the first spindle.

In order to resolve the above problem, a disk surface inspection method in accordance with an aspect of the present invention comprises the steps of: extracting a disk from a cassette and mounting the disk on a spindle; irradiating the disk mounted on the spindle with light and condensing and detecting reflected light from the irradiated disk while moving the spindle in an axial direction and driving and rotating the spindle along with detecting the rotation angle of the spindle; detecting defects on the disk by processing a signal generated by the condensation and the detection of the reflected light from the disk; and outputting the result of the detection of the defects. In the processing of the signal generated by the detection of the reflected light from the disk, the position of each of the detected defects is stored after converting the position into positional information with reference to the position of a particular part of the disk by use of rotation angle information on the spindle acquired from a signal generated by detecting the rotation angle of the spindle and positional information on a particular part of the disk stored in the cassette.

In order to resolve the above problem, a disk surface inspection method in accordance with another aspect of the present invention comprises the steps of: extracting a disk from a cassette and mounting the disk on a first spindle with a first side of the disk facing upward; irradiating the first side of the disk mounted on the first spindle with light and condensing and detecting reflected light from the irradiated first side of the disk while moving the first spindle in an axial direction and driving and rotating the first spindle along with detecting the rotation angle of the first spindle; detecting defects on the first side of the disk by processing a signal generated by the condensation and the detection of the reflected light from the first side of the disk; removing the disk from the first spindle, inverting and conveying the disk, and mounting the disk on a second spindle with a second side of the disk facing upward; irradiating the second side of the disk mounted on the second spindle with light and condensing and detecting reflected light from the irradiated second side of the disk while moving the second spindle in an axial direction and driving and rotating the second spindle along with detecting the rotation angle of the second spindle; detecting defects on the second side of the disk by processing a signal generated by the condensation and the detection of the reflected light from the second side of the disk; and outputting the result of the detection of the defects on the first side of the disk and the result of the detection of the defects on the second side of the disk. In the processing of the signal generated by the detection of the reflected light from the first side of the disk, the position of each of the detected defects is stored after converting the position into positional information with reference to the position of a particular part of the disk by use of rotation angle information on the first spindle acquired from a signal generated by detecting the rotation angle of the first spindle and positional information on a particular part of the disk stored in the cassette. In the processing of the signal generated by the detection of the reflected light from the second side of the disk, the position of each of the detected defects is stored after converting the position into positional information with reference to the position of a particular part of the disk by use of rotation angle information on the second spindle and positional information on a particular part of the disk just before being removed from the first spindle.

According to the present invention, inspection considerably fixing the positions of the disks from the washing process is made possible by carrying out the inspection by fixing not only the radial positions but also the angular positions of the disks. This makes it possible to find out failure in the washing process (washing device) on the inspection device's side.

These features and advantages of the invention will be apparent from the following more particular description of preferred embodiments of the invention, as illustrated in the accompanying drawings.

### BRIEF DESCRIPTION OF THE DRAWINGS

FIG. 1A is a block diagram showing the overall configuration of a disk surface inspection device in accordance with an embodiment of the present invention.

FIG. 1B is a vertical sectional view of a cassette showing a state in which a magnetic disk has been stored in the cassette.

FIG. 2 is a block diagram showing the configuration of a first table unit, a second table unit, an optical inspection unit and a control unit of the disk surface inspection device in accordance with the embodiment of the present invention.

FIG. 3 is a flow chart showing a process flow of the disk surface inspection device in accordance with the embodiment of the present invention.

FIG. 4 is a flow chart showing a process flow for classifying detected defects in accordance with the embodiment of the present invention.

FIG. 5A shows defect maps indicating the distribution of defects detected on a plurality of substrates when the positions of occurrence of circumferential defects and island-like defects are plotted with reference to the origin of the magnetic disk.

FIG. 5B shows defect maps indicating the distribution of defects detected on a plurality of substrates by a conventional method that does not execute conversion from a defect signal into angular information with reference to the origin of the magnetic disk.

FIG. 6 is a front view of a display screen of an output unit displaying an inspection result in accordance with the embodiment of the present invention.

### DESCRIPTION OF THE PREFERRED EMBODIMENTS

In the series of processes for washing the surfaces of disks (e.g., magnetic disks) and drying the washed disk surfaces, which are processed in a state stored in a cassette, the disks after the washing are conveyed to the drying process by the cassette. Therefore, the positional relationship in the circumferential direction among the disks in the washing device stored in the cassette in the washing process is remained constant in the disks in the cassette after the drying process.

The present invention relates to an inspection device which extracts each disk (conveyed thereto in a cassette after the drying process) from the cassette one by one and inspects defects existing on the surface(s) of the disk (e.g., magnetic disk).

In the process for washing the disks, the disk surfaces during the washing can be damaged (e.g., scratch) by a particular part of the washing device. When such damage by the washing device has occurred, proper countermeasures have to be taken by immediately spotting the part of the washing device that caused the damage. However, each disk surface generally has no pattern or mark usable for checking the position of the disk in the circumferential direction (circumferential position) and thus it is difficult to determine whether or not the defects of the disks detected by the inspection have occurred at the same position on the disks (in the circumferential direction and in the radial direction) due to the same cause in a previous process (in this case, the washing process).

In consideration of the above situation, the present invention has been made by taking advantage of the aforementioned characteristics that the positional relationship among the disks in the washing device in the washing process in regard to the circumferential direction is maintained constant and the disks after the drying process (stored in a cassette) are conveyed to the inspection device by the cassette while maintaining their positional relationship in there.

Specifically, with reference to the circumferential position (position in the circumferential direction) of the disk stored in the cassette (e.g., by regarding the top (highest point) of the disk stored in the cassette as the reference position in regard to the angular orientation (that is, the origin), the inspection device is configured to be able to securely recognize the reference position of each disk. After the inspection of each disk, the inspection device stores the inspection data (obtained by the inspection) while associating it with angular information based on the reference position.

Consequently, the inspection data of a plurality of disks can be integrated with high reliability by use of the angular information and the radial position information on each defect with respect to the reference position, by which the determination of defects that occurred at the same position on a plurality of disks is made possible.

This enables the determination of the defect occurrence positions (positions of occurrence of the defects) in a previous process and facilitates the analysis of the causes of the detects.

Referring now to the drawings, a description will be given in detail of a preferred embodiment in accordance with the present invention.

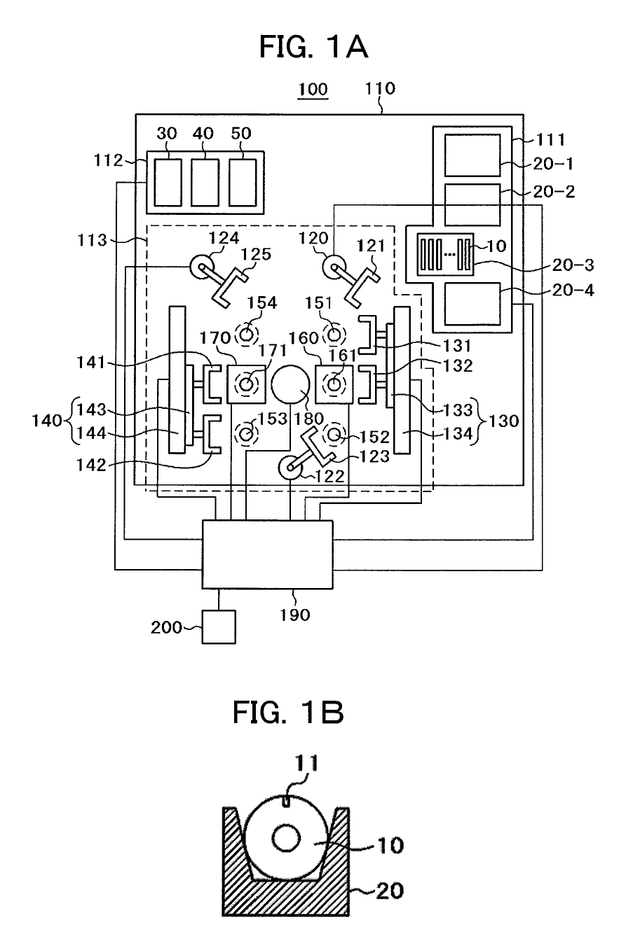

FIG. 1A is a plan view of a disk surface inspection device 100 in accordance with this embodiment. The disk surface inspection device 100 comprises an inspection mechanism unit 110, a control unit 190, and an output unit 200.

The control unit 190 controls the operation of each part of the inspection mechanism unit 110 while classifying detected defects by processing a defect signal outputted by the inspection mechanism unit 110 detecting the defects. The output unit 200 outputs the result of the processing by the control unit 190.

In this embodiment, a case where magnetic disks are inspected as the inspection target disks will be described as an example.

The inspection mechanism unit 110 includes a cassette conveyance unit 111, a post-inspection magnetic disk cassette storage unit 112, and a defect inspection unit 113. The cassette conveyance unit 111 successively conveys cassettes 20-1, 20-2 and 20-3 storing magnetic disks 10 with dried surfaces which have been sent from the drying process (not shown) and a vacant cassette 20-4 after the inspection of the stored magnetic disks. The post-inspection magnetic disk cassette storage unit 112 stores cassettes 30, 40 and 50 which are used for storing the inspected magnetic disks depending on the result of the inspection. Specifically, the cassette 30 is used for storing magnetic disks on which the number of the detected defects (per surface) is less than a reference value on both sides (front side, back side). The cassette 40 is used for storing magnetic disks on which the number of the detected defects is the reference value or more on one side. The cassette 50 is used for storing magnetic disks on which the number of the detected defects is the reference value or more on both sides.

The defect inspection unit 113 includes a first handling robot 120, a second handling robot 122, a third handling robot 124, a first magnetic disk conveyance unit 130, a second magnetic disk conveyance unit 140, a first table unit 160, a second table unit 170, and an optical inspection unit 180. The first handling robot 120 extracts each magnetic disk 10 from the cassette 20-3 by holding the magnetic disk 10 with a claw part 121 and temporarily sets the extracted magnetic disk 10 on a first temporary setting table 151. The first table unit 160 is equipped with a first spindle 161 which rotates the magnetic disk 10 set thereon. The first magnetic disk conveyance unit 130 includes a slide 133 having claw parts 131 and 132 fixed thereon and a slide base 134 for guiding the movement of the slide 133. The first magnetic disk conveyance unit 130 conveys the magnetic disk 10 temporary set on the first temporary setting table 151 to the first spindle 161, while also conveying the magnetic disk 10 after the inspection of the front side from the first spindle 161 to a second temporary setting table 152. The second handling robot 122 inverts the magnetic disk 10 (after undergoing the inspection of the front side and being conveyed to the second temporary setting table 152 by the first magnetic disk conveyance unit 130) by holding it with a claw part 123 and then temporarily sets the magnetic disk 10 on a third temporary setting table 153 with the magnetic disk's back side facing upward. The second table unit 170 is equipped with a second spindle 171 which rotates the magnetic disk 10 set thereon with the back side facing upward. The second magnetic disk conveyance unit 140 includes a slide 143 having claw parts 141 and 142 fixed thereon and a slide base 144 for guiding the movement of the slide 143. The second magnetic disk conveyance unit 140 conveys the magnetic disk 10 (temporarily set on the third temporary setting table 153 with the back side facing upward) to the second spindle 171, while also conveying the magnetic disk 10 after the inspection of the back side from the second spindle 171 to a fourth temporary setting table 154. The optical inspection unit 180 optically inspects the front side or the back side of the magnetic disk 10 set on the first spindle 161 or the second spindle 171. The third handling robot 124 picks up the magnetic disk 10 (after undergoing the inspection of the front side and the back side and being conveyed to the fourth temporary setting table 154 by the second magnetic disk conveyance unit 140) by holding it with a claw part 125 and then stores the magnetic disk 10 in the non-defective disk storage cassette 30, the one-side defective disk storage cassette 40 or the both-side defective disk storage cassette 50 depending on the result of the inspection.

The control unit 190 controls the cassette conveyance unit 111, the post-inspection magnetic disk cassette storage unit 112, the first handling robot 120, the first table unit 160, the optical inspection unit 180, the first magnetic disk conveyance unit 130, the second handling robot 122, the second magnetic disk conveyance unit 140, the second table unit 170 and the third handling robot 124 of the inspection mechanism unit 110 and thereby controls the sequence of operations for extracting each magnetic disk 10 from the cassette, successively inspecting the front side and the back side of the magnetic disk 10, and storing the inspected magnetic disk 10 in one of the storage cassettes 30, 40 and 50 depending on the result of the inspection.

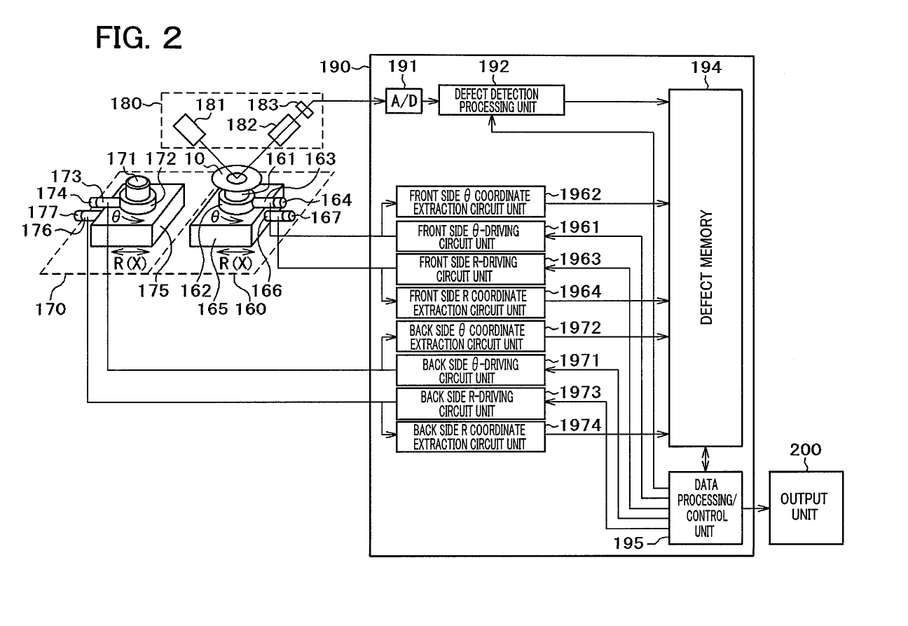

Next, the detailed configuration of the first table unit 160, the second table unit 170, the optical inspection unit 180 and the control unit 190 will be explained below referring to FIG. 2.

The optical inspection unit 180 includes an illumination optical system 181 which illuminates the upper surface of the magnetic disk 10 with light, a detection optical system 182 which condenses reflected light from the upper surface of the magnetic disk 10 irradiated with the light from the illumination optical system 181, and a detector 183 which detects the reflected light from the upper surface of the magnetic disk 10 condensed by the detection optical system 182 and outputs an electric signal corresponding to the amount of the detected reflected light.

The first table unit 160 includes a spindle 161, a rotary driving unit 162, a rotary driving motor 163, a rotary encoder 164, an X stage 165, a linear driving motor 166, and another rotary encoder 167. The spindle 161 rotates the magnetic disk 10 set thereon. The rotary driving unit 162 drives and rotates the spindle 161. The rotary driving motor 163 serves as the driving source of the rotary driving unit 162. The rotary encoder 164 detects the rotation angle of the rotary driving motor 163. The X stage 165 linearly moves the spindle 161 in a radial direction (X direction) of the magnetic disk 10. The linear driving motor 166 serves as the driving source of the X stage 165. The rotary encoder 167 detects the rotation angle of the linear driving motor 166.

The second table unit 170 includes a spindle 171, a rotary driving unit 172, a rotary driving motor 173, a rotary encoder 174, an X stage 175, a linear driving motor 176, and another rotary encoder 177. The spindle 171 rotates the magnetic disk 10 set thereon. The rotary driving unit 172 drives and rotates the spindle 171. The rotary driving motor 173 serves as the driving source of the rotary driving unit 172. The rotary encoder 174 detects the rotation angle of the rotary driving motor 173. The X stage 175 linearly moves the spindle 171 in a radial direction (X direction) of the magnetic disk 10. The linear driving motor 176 serves as the driving source of the X stage 175. The rotary encoder 177 detects the rotation angle of the linear driving motor 176.

The output from the detector 183 detecting the reflected light from the upper surface of the magnetic disk 10 condensed by the detection optical system 182 is inputted to the control unit 190, converted by an A/D converter 191 into a digital signal, and inputted to a defect detection processing unit 192. Detection signals stronger than a preset signal level are detected as defects. Information on the detected defects is sent to a defect memory unit 194.

In the inspection performed at the first table unit 160, the rotary driving unit 162 is driven by the rotary driving motor 163 controlled by a θ-driving circuit unit 1961, and the rotation angle of the spindle 161 is monitored by a θ coordinate extraction circuit unit 1962 based on a signal supplied from the rotary encoder 164. Information representing the rotation angle of the spindle 161 monitored by the θ coordinate extraction circuit unit 1962 (rotation angle information) is sent to the defect memory 194.

The X stage 165 is driven by the linear driving motor 166 controlled by an R-driving circuit unit 1963. The R coordinate position (X coordinate position) of the spindle 161 is monitored by an R coordinate extraction circuit unit 1964 based on a signal supplied from the rotary encoder 167. Information representing the R coordinate position of the spindle 161 monitored by the R coordinate extraction circuit unit 1964 (R coordinate position information) is sent to the defect memory 194.

On the other hand, in the inspection performed at the second table unit 170, the rotary driving unit 172 is driven by the rotary driving motor 173 controlled by a θ-driving circuit unit 1971, and the rotation angle of the spindle 171 is monitored by a θ coordinate extraction circuit unit 1972 based on a signal outputted from the rotary encoder 174. Information representing the rotation angle of the spindle 171 monitored by the θ coordinate extraction circuit unit 1972 (rotation angle information) is sent to the defect memory 194.

The X stage 175 is driven by the linear driving motor 176 controlled by an R-driving circuit unit 1973. The R coordinate position (X coordinate position) of the spindle 171 is monitored by an R coordinate extraction circuit unit 1974 based on a signal outputted from the rotary encoder 177. Information representing the R coordinate position of the spindle 171 monitored by the R coordinate extraction circuit unit 1974 (R coordinate position information) is sent to the defect memory 194.

In the defect memory 194, each defect detected by the defect detection processing unit 192 is memorized while associating it with R-θ information on the magnetic disk 10 by extracting the detect information outputted by the defect detection processing unit 192, the rotation angle information on the spindle 161 monitored by the θ coordinate extraction circuit unit 1962 (or the rotation angle information on the spindle 171 monitored by the θ coordinate extraction circuit unit 1972) at that time, and the R coordinate position information on the spindle 161 monitored by the R coordinate extraction circuit unit 1964 (or the R coordinate position information on the spindle 171 monitored by the R coordinate extraction circuit unit 1974) at that time.

The detect information associated with the R-θ information in the defect memory 194 is sent to a data processing unit 195 which judges the shape and the size of each defect.

As shown in FIG. 1B, when each magnetic disk 10 after undergoing the washing process and the drying process is conveyed to the inspection mechanism unit 110, in a state that the same part of the magnetic disk 10 stored in the storage cassette 20 is kept at the top 11 (highest position). In the configuration shown in FIG. 1A, the first handling robot 120 conveys each magnetic disk 10 (which has been stored in the storage cassette 20-3) to the first temporary setting table 151 in a constant state every time. The first magnetic disk conveyance unit 130 sets the magnetic disk 10 (temporarily set on the first temporary setting table 151) on the spindle 161 of the first table unit 160 in the same state. Therefore, the positional relationship in the circumferential direction (rotating direction) between the magnetic disk 10 set on the spindle 161 and the (same) magnetic disk 10 stored in the storage cassette 20-3 is always constant.

Therefore, the θ coordinate (rotation angle) of the magnetic disk substrate 10 set on the spindle 161 and rotating together with the spindle 161 (i.e., the angle of the magnetic disk 10 with reference to the top of the magnetic disk 10 stored in the storage cassette 20-3) can be monitored by making the θ coordinate extraction circuit unit 1962 monitor the signal from the rotary encoder 164 which corresponds to the rotation angle of the spindle 161 (driven and controlled by the θ-driving circuit unit 1961) after the start of the rotation after the magnetic disk 10 is set on the spindle 161. Incidentally, while this explanation is given by using the top of the magnetic disk 10 as the reference point for the sake of convenience, other positions such as the bottom (lowest point) or the rightmost/leftmost point (90 degrees from the top) of the magnetic disk 10 may also be used as the reference point since this embodiment takes advantage of the characteristic that the positional relationship in the circumferential direction (rotating direction) between the magnetic disk 10 set on the spindle 161 and the (same) magnetic disk 10 stored in the storage cassette 20-3 is always constant.

Further, similarly to the above explanation, the positions (in the rotation angle direction) of the magnetic disk 10 from the moment of being removed from the spindle 161 to the moment of being set on the spindle 171 are always in constant relationship with the state (position) just before being removed from the spindle 161. Therefore, by storing information on the θ coordinate (rotation angle) of the magnetic disk 10 just after the inspection performed at the first table unit 160, it is possible to monitor the angle of the back side (back surface) of the magnetic disk 10 with reference to the top of the magnetic disk 10 stored in the storage cassette 20-3 (similarly to the explanation of the inspection at the first table unit 160) when the back side of the magnetic disk 10 is inspected at the second table unit 170.

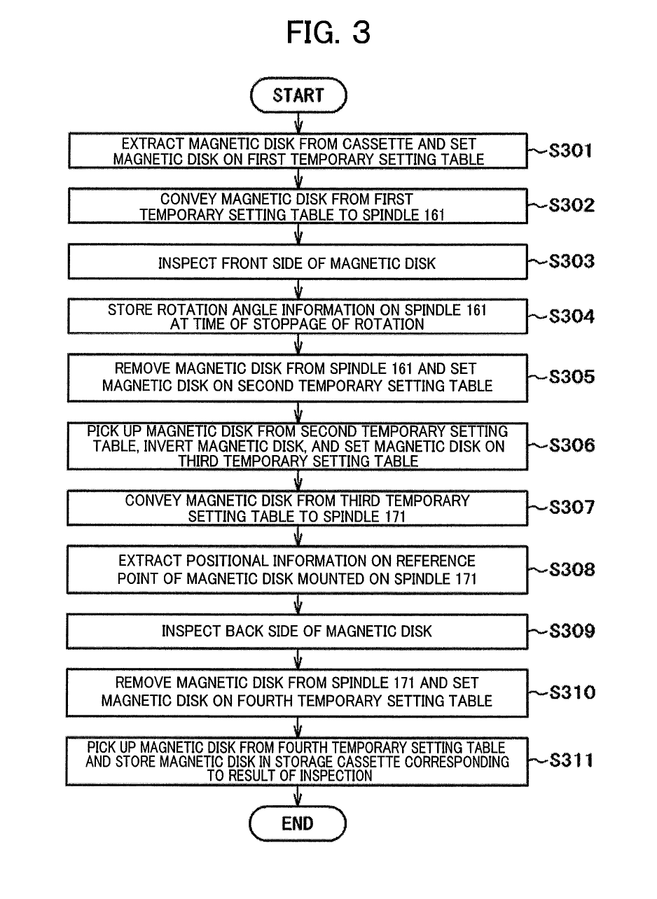

Next, the process flow of the disk surface inspection device 100 extracting one magnetic disk 10 from the storage cassette 20-3, inspecting the front side and the back side of the magnetic disk 10, and storing the inspected magnetic disk 10 in the storage cassette 30, 40 or 50 will be described below referring to FIG. 3.

First, a magnetic disk 10 stored in the cassette 20-3 in the cassette conveyance unit 111 (after undergoing the washing process and the drying process) is held by the claw part 121 of the first handling robot 120, extracted from the storage cassette 20-3, and set on the first temporary setting table 151 (S301). Subsequently, the magnetic disk 10 set on the first temporary setting table 151 is held by the claw part 131 of the first magnetic disk conveyance unit 130, conveyed to the first spindle 161 of the first table unit 160 by the movement of the slide 133 along the slide base 134 under the control of the control unit 190, and mounted on the first spindle 161 (S302).

Subsequently, the inspection of the front side of the magnetic disk 10 is carried out by the optical inspection unit 180 (S303) while the first spindle 161 with the magnetic disk 10 mounted thereon is driven and rotated by the rotary driving motor 163 controlled by the θ-driving circuit unit 1961 and the X stage 165 is driven and moved at a constant speed in the R direction (X direction) by the linear driving motor 166 controlled by the R-driving circuit unit 1963. In this case, the position of the (former) top of the magnetic disk 10 formerly stored in the cassette 20-3 is already clear at the time of mounting the magnetic disk 10 on the first spindle 161 as mentioned above. Therefore, each defect on the front side of the magnetic disk 10 detected by the optical inspection unit 180 can be memorized while associating it with the angular information on the magnetic disk, by sending the rotation angle of the spindle 161 (driven and rotated by the rotary driving motor 163 controlled by the θ-driving circuit unit 1961) to the defect memory unit 194 by monitoring the output signal from the rotary encoder 164 with the θ coordinate extraction circuit unit 1962.

At the same time, each of the detected defects can be memorized while associating it also with the R coordinate, by also sending the R coordinate information on the spindle 161 (acquired by monitoring the output signal from the rotary encoder 167 with the R coordinate extraction circuit unit 1964) to the defect memory unit 194. In the defect memory unit 194, conversion to angular information with respect to the reference position of the magnetic disk 10 is executed by use of the θ coordinate information on the detected defect, and the angular information acquired by the conversion is stored together with the R coordinate information.

After the inspection of the front side of the magnetic disk 10 by the optical inspection unit 180 is finished, the rotation of the spindle 161 is stopped by the θ-driving circuit unit 1961 by stopping the driving of the rotary driving motor 163. The rotation angle of the spindle 161 at the time of the stoppage is monitored by the θ coordinate extraction circuit unit 1962 based on the output signal from the rotary encoder 164, sent to the defect memory unit 194, and stored in the defect memory unit 194 for later use (S304).

Subsequently, in the state in which the rotation of the spindle 161 has stopped completely, the magnetic disk 10 is picked up from the spindle 161 by the claw part 132 of the first magnetic disk conveyance unit 130, moved to the second temporary setting table 152 by the movement of the slide 133 along the slide base 134 under the control of the control unit 190, and set on the second temporary setting table 152 (S305). Subsequently, the magnetic disk 10 set on the second temporary setting table 152 is picked up from the table 152 by the claw part 123 of the second handling robot 122, inverted, and set on the third temporary setting table 153 with its back side facing upward (S306).

The magnetic disk 10 set on the third temporary setting table 153 is picked up from the table 153 by the claw part 142 of the second magnetic disk conveyance unit 140 and then mounted on the spindle 171 of the second table unit 170 by the movement of the slide 143 along the slide guide 144 under the control of the control unit 190 (S307). In this case, the amount of change in the circumferential position of the magnetic disk 10 (the position of the magnetic disk 10 in the circumferential direction) from the removal from the spindle 161 to the mounting on the spindle 171 is constant every time. Therefore, the reference position of the magnetic disk 10 at the time of being mounted on the spindle 171 can be determined from the rotation angle information on the spindle 161 at the time of the stoppage of rotation which has previously been stored in the defect memory 194 (S308).

Subsequently, the inspection of the back side of the magnetic disk 10 is carried out by the optical inspection unit 180 (S309) while the spindle 171 with the magnetic disk 10 mounted thereon is driven and rotated by the rotary driving motor 173 controlled by the θ-driving circuit unit 1971 and the X stage 175 is driven and moved at a constant speed in the R direction (X direction) by the linear driving motor 176 controlled by the R-driving circuit unit 1973.

In this case, each defect on the back side of the magnetic disk 10 detected by the optical inspection unit 180 can be memorized while associating it with the angular information on the magnetic disk, by sending the rotation angle of the spindle 171 (driven and rotated by the rotary driving motor 173 controlled by the θ-driving circuit unit 1971) to the defect memory unit 194 by monitoring the output signal from the rotary encoder 174 with the θ coordinate extraction circuit unit 1972. At the same time, each of the detected defects can be memorized while associating it also with the R coordinate, by also sending the R coordinate information on the spindle 171 (acquired by monitoring the output signal from the rotary encoder 177 with the R coordinate extraction circuit unit 1974) to the defect memory unit 194.

In the defect memory unit 194, conversion to angular information with respect to the reference position of the magnetic disk 10 is executed by use of the θ coordinate information on the detected defect, and the angular information acquired by the conversion is stored together with the R coordinate information. After the inspection of the back side of the magnetic disk 10 by the optical inspection unit 180 is finished, the rotation of the spindle 171 is stopped by the θ-driving circuit unit 1971.

Subsequently, the magnetic disk 10 after undergoing the inspection of the back side is picked up from the spindle 171 by the claw part 141 of the second magnetic disk conveyance unit 140 and set on the fourth temporary setting table 154 by the movement of the slide 143 along the slide guide 144 under the control of the control unit 190 (S310). Finally, the magnetic disk 10 set on the fourth temporary setting table 154 after the completion of the inspection is held by the claw part 125 of the third handling robot 124, picked up from the fourth temporary setting table 154, and stored in the storage cassette 30, 40 or 50 depending on the result of the inspection of the front side and the back side (S311).

While the process flow of the disk surface inspection device 100 extracting one magnetic disk 10 from the storage cassette 20-3, inspecting the front side and the back side of the magnetic disk 10, and storing the inspected magnetic disk 10 in the storage cassette 30, 40 or 50 is basically as described above, the actual inspection is carried out by inspecting two substrates alternately. Specifically, the front side of the second substrate is inspected while the first substrate after undergoing the front side inspection is conveyed to the spindle 171 for the back side inspection. The back side inspection of the first substrate is carried out while the second substrate is removed from the spindle 161 and conveyed for the back side inspection.

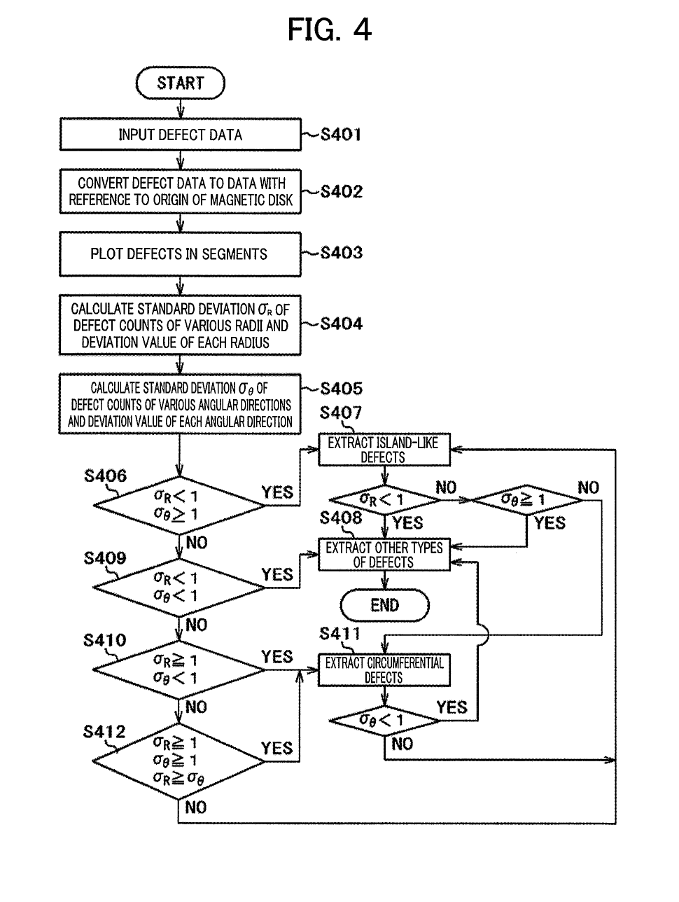

Next, the flow of a process executed by the data processing/control unit 195 of the control unit 190 in response to a defect detection signal from the defect memory 194 will be described below referring to FIG. 4.

From the detection signals outputted by the detector 183 of the optical inspection unit 180, the defect detection processing unit 192 extracts detection signals stronger than a reference signal (preset to the data processing/control unit 195) by use of the reference signal and sends information on the extracted detection signals (defect signals) to the defect memory 194. For the sake of simplicity, the explanation of this extraction process will be given only about the inspection in the first table unit 160. The extraction process for the inspection in the second table unit 170 is also executed similarly. The defect memory 194 receiving the information on a defect signal (extracted detection signal) from the defect detection processing unit 192 stores the information on the defect signal while associating it with the rotation angle information on the spindle 161 supplied from the front side θ coordinate extraction circuit unit 1962 and the R coordinate information on the spindle 161 supplied from the front side R coordinate extraction circuit unit 1964 corresponding to the defect signal information inputted from the defect detection processing unit 192.

To the data processing/control unit 195, each defect signal stored in the defect memory 194 while being associated with the rotation angle (circumferential) information and the R coordinate information is inputted (S401). The data processing/control unit 195 executes the conversion to the angular information on the detected defect with reference to the origin of the magnetic disk 10 (S402) by use of the rotation angle information on the spindle 161 and the information on the angle of the origin of the magnetic disk 10 set on the spindle 161 (the position of the (former) top of the magnetic disk 10 formerly stored in the cassette 20-3) with respect to the spindle 161 (e.g., rotation angle information with reference to the R direction in which the spindle 161 moves).

Subsequently, by using the converted angular information (circumferential information) and the R coordinate information, the data processing/control unit 195 plots the detected defects in segment regions (segments) acquired by segmenting the magnetic disk area (corresponding to the magnetic disk) in the angular direction and in the radial direction into a lot of regions (S403). The data processing/control unit 195 counts the number of defects existing in segments of the same radius (same radius range) and thereby calculates the standard deviation σ_{R} of the numbers of defects existing at various radii and the deviation value of each radius (S404). Similarly, the data processing/control unit 195 counts the number of defects existing in segments in the same angular direction (same angular direction range) and thereby calculates the standard deviation σ_{θ} of the numbers of defects existing in various angular directions and the deviation value of each angular direction (S405).

Subsequently, the data processing/control unit 195 checks whether or not the standard deviation σ_{R} of the numbers of defects existing at various radii is less than 1 and the standard deviation σ_{θ} of the numbers of defects existing in various angular directions is 1 or more (S406). If the standard deviation σ_{R} is less than 1 and the standard deviation σ_{θ} is 1 or more (S406: YES), the data processing/control unit 195 executes an extraction process for extracting island-like defects (S407) and thereafter executes an extraction process for extracting “other types of defects” other than the island-like defects or circumferential defects (S408).

The data processing/control unit 195 further checks whether or not the standard deviation σ_{R} is less than 1 and the standard deviation σ_{θ} is also less than 1 (S409). If the standard deviation σ_{R} is less than 1 and the standard deviation σ_{θ} is also less than 1 (S409: YES), the data processing/control unit 195 executes the extraction process for extracting the other types of defects other than the island-like defects or the circumferential defects (S408).

The data processing/control unit 195 further checks whether or not the standard deviation σ_{R} is 1 or more and the standard deviation σ_{θ} is less than 1 (S410). If the standard deviation σ_{R} is 1 or more and the standard deviation σ_{θ} is less than 1 (S410: YES), the data processing/control unit 195 executes an extraction process for extracting the circumferential defects (S411) and thereafter executes the extraction process for extracting the other types of defects other than the island-like defects or the circumferential defects (S408).

Finally, when both of the standard deviations σ_{R} and σ_{θ} are 1 or more, the data processing/control unit 195 compares the standard deviations σ_{R} and σ_{θ} (S412). If the standard deviation σ_{R} is greater than or equal to the standard deviation σ_{θ} (S412: YES), the data processing/control unit 195 executes the extraction process for extracting the circumferential defects (S411), thereafter executes the extraction process for extracting the island-like defects (S407), and finally executes the extraction process for extracting the other types of defects (S408). If the standard deviation σ_{R} is less than the standard deviation σ_{θ} (S412: NO), the data processing/control unit 195 executes the extraction process for extracting the island-like defects (S407), thereafter executes the extraction process for extracting the other types of defects (S408).

The island-like defect extraction process (S407) and the circumferential defect extraction process (S411) are equivalent to the methods described in the aforementioned Patent Literature 1, and thus detailed explanation thereof is omitted.

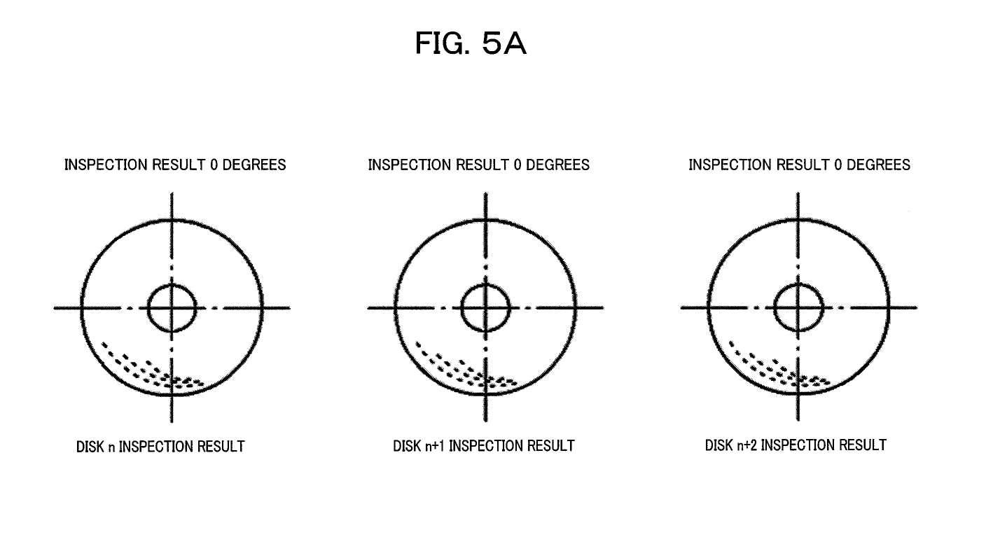

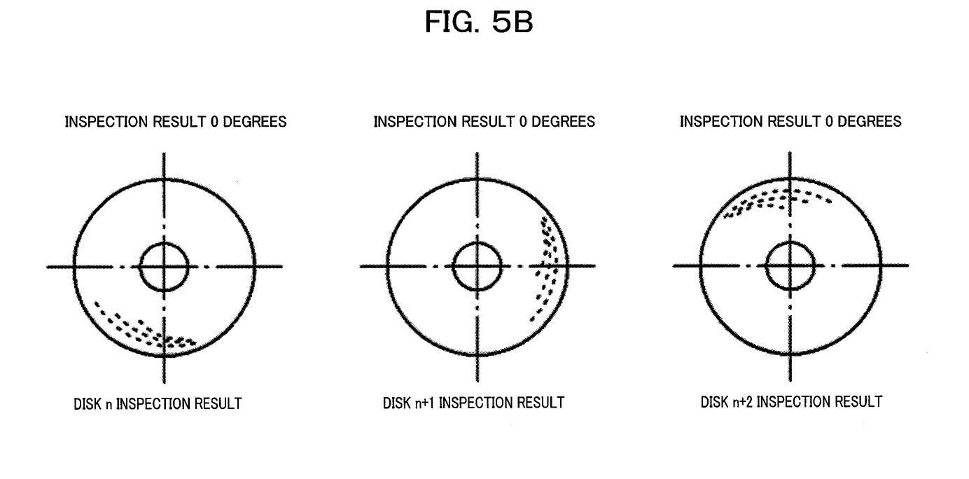

In the step S402 of the process flow explained above, the inputted defect signal (associated with the rotation angle information and the R coordinate information stored in the defect memory 194) is converted into the angular information with reference to the origin of the magnetic disk 10. Thus, the positions of occurrence of the circumferential defects and the island-like defects detected in the subsequent steps can be compared as shown in FIG. 5A among a plurality of substrates (disk n, disk n+1, and disk n+2 in the example of FIG. 5A) with reference to the origin of the magnetic disk 10 (0 degree position in the inspection result in the example of FIG. 5A). In contrast, in the conventional method not executing the conversion from the defect signal to the angular information with reference to the origin of the magnetic disk 10, the positional information on the detected defects varies each time as shown in FIG. 5B. Since the 0 degree position in the inspection result varies from substrate to substrate, it is impossible to compare the defects among a plurality of substrates even if the inspection data on a plurality of substrates are stacked up with reference to the 0 degree position in the inspection result.

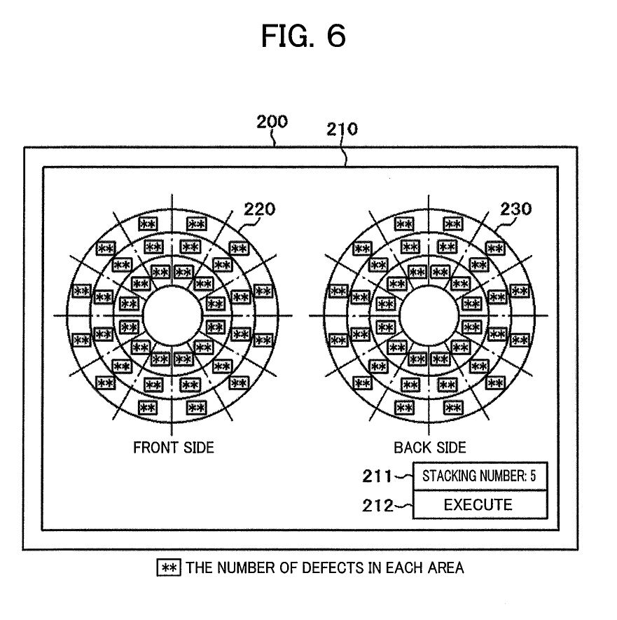

FIG. 6 shows an example of the display of the inspection result on the display screen of the output unit 200. A map 220 indicating the distribution of the defects on the front side of the magnetic disk and a map 230 indicating the distribution of the defects on the back side of the magnetic disk are displayed on the display screen of the output unit 200.

In the maps 220 and 230, each segment (each of the regions segmented by dotted lines) is displayed in a color corresponding to the number of defects detected in the segment. The number displayed in the area 211 in the lower right of the screen represents the number of substrates for which the defect information is stacked up (superimposed together). The operator specifies a desired stacking number on the screen and clicks on the execution button 212, by which the defect data of the specified number of disks can be stacked up and displayed on the maps 220 and 230. The display of the segments can also be made by integrating segments corresponding to the same radius or the same angle into one segment. The segments may be displayed in different colors according to the number of defects.

By displaying the inspection results of a plurality of magnetic disks while unifying the positions of the magnetic disks as described above, defects occurring locally can be exaggerated in the display, which facilitates the determination of the defect occurrence positions in the washing process.

While the washing device is not judged to be in an abnormal state in the conventional technique in which the angular positions of the defects are random, the disk surface inspection device in accordance with this embodiment sets a common coordinate origin on the inspection target magnetic disks and unifies the angles on the magnetic disks as described above. This makes it possible to detect the abnormal state of the washing device and immediately stop the washing device in cases where the detected defects concentrate in a particular area on consecutive disks.

Further, by judging in which area(s) the defects concentrate, the determination of the positions of occurrence of defects (problems in the washing device) can be carried out on the inspection device. For example, when the defects concentrate in a lower part of the disks, there is a possibility of waterdrops remaining as specks due to insufficient drying after the washing. In this case, the washing device is subjected to countermeasures to eliminate the problem.

While an embodiment in accordance with the present invention has been described above, the present invention is not to be restricted to the above particular illustrative embodiment but can contain a variety of modifications. For example, the above embodiment has been described in detail to clearly explain the present invention and thus embodiments in accordance with the present invention are not necessarily required to contain all the features described above. It is possible to replace some features of one embodiment with some features of another embodiment or to add some features of one embodiment to another embodiment. Addition, deletion, replacement, etc. may be made for part of the features of each embodiment by using other embodiments as needed.

What is claimed is:

1. A disk surface inspection device comprising:
conveyance means which extracts a disk from a cassette and conveys the disk;
table means including a spindle on which the disk conveyed by the conveyance means is mounted, a rotary driving unit which drives and rotates the spindle, a rotation angle detecting unit which detects the rotation angle of the spindle, and a linear driving unit which drives the spindle in an axial direction;
optical detection means including a light irradiation unit which irradiates the disk mounted on the spindle with light and a condensation/detection unit which condenses and detects reflected light from the disk irradiated with the light from the light irradiation unit;
signal processing means which detects defects on the disk by processing a signal from the optical detection means condensing and detecting the reflected light from the disk; and
output means which outputs the result of the processing by the signal processing means,
wherein the signal processing means stores the position of each of the detected defects after converting the position into positional information with reference to the position of a particular part of the disk by use of rotation angle information on the spindle outputted by the rotation angle detecting unit of the table means and positional information on a particular part of the disk stored in the cassette.

2. The disk surface inspection device according to claim 1, wherein:
the output means has a display screen, and
the output means displays the information on the defects, detected and stored by the signal processing means after the conversion into the positional information with reference to the position of the particular part of the disk, on the display screen while stacking up the information in regard to a plurality of disks.

3. The disk surface inspection device according to claim 2, wherein:
the number of disks for which the information on the defects should be stacked up is specified on the display screen, and
the information on the defects is displayed on the display screen while stacking up the information in regard to the specified number of disks.

4. The disk surface inspection device according to claim 2, wherein the output means displays the information on the defects on front and back sides of each disk side by side on the display screen while stacking up the information in regard to a plurality of disks.

5. A disk surface inspection device comprising:
first conveyance means which extracts a disk from a cassette and conveys the disk;
first table means including a first spindle on which the disk conveyed by the first conveyance means is mounted, a rotary driving unit which drives and rotates the first spindle, a first rotation angle detecting unit which detects the rotation angle of the first spindle, and a first linear driving unit which drives the first spindle in an axial direction;
second conveyance means which removes the disk from the first spindle, inverts the disk, and conveys the inverted disk;
second table means including a second spindle on which the inverted disk conveyed by the second conveyance means is mounted, a rotary driving unit which drives and rotates the second spindle, a second rotation angle detecting unit which detects the rotation angle of the second spindle, and a second linear driving unit which drives the second spindle in an axial direction;
optical detection means including a light irradiation unit which irradiates the disk mounted on the first spindle or the second spindle with light and a condensation/detection unit which condenses and detects reflected light from the disk irradiated with the light from the light irradiation unit;
signal processing means which detects defects on the disk by processing a signal from the optical detection means which condenses and detects the reflected light from the disk; and
output means which outputs the result of the processing by the signal processing means, wherein:
the signal processing means stores the position of each of the defects detected on the disk mounted on the first spindle after converting the position into positional information with reference to the position of a particular part of the disk by use of rotation angle information on the first spindle outputted by the first rotation angle detecting unit of the first table means and positional information on a particular part of the disk stored in the cassette, and
the signal processing means stores the position of each of the defects detected on the inverted disk mounted on the second spindle after converting the position into positional information with reference to the position of a particular part of the disk by use of rotation angle information on the second spindle outputted by the second rotation angle detecting unit of the second table means and positional information on a particular part of the disk just before being removed from the first spindle.

6. The disk surface inspection device according to claim 5, wherein:
the output means has a display screen, and
the output means displays the information on the defects, detected and stored by the signal processing means after the conversion into the positional information with reference to the position of the particular part of the disk, on the display screen while stacking up the information in regard to a plurality of disks.

7. The disk surface inspection device according to claim 6, wherein:
the number of disks for which the information on the defects should be stacked up is specified on the display screen, and
the information on the defects is displayed on the display screen while stacking up the information in regard to the specified number of disks.

8. The disk surface inspection device according to claim 6, wherein the output means displays the information on the defects on front and back sides of each disk side by side on the display screen while stacking up the information in regard to a plurality of disks.

9. A disk surface inspection method comprising the steps of:
extracting a disk from a cassette and mounting the disk on a spindle;
irradiating the disk mounted on the spindle with light and condensing and detecting reflected light from the irradiated disk while moving the spindle in an axial direction and driving and rotating the spindle along with detecting the rotation angle of the spindle;
detecting defects on the disk by processing a signal generated by the condensation and the detection of the reflected light from the disk; and
outputting the result of the detection of the defects, wherein:
in the processing of the signal generated by the detection of the reflected light from the disk, the position of each of the detected defects is stored after converting the position into positional information with reference to the position of a particular part of the disk by use of rotation angle information on the spindle acquired from a signal generated by detecting the rotation angle of the spindle and positional information on a particular part of the disk stored in the cassette.

10. The disk surface inspection method according to claim 9, wherein the information on the defects detected and stored after the conversion into the positional information with reference to the position of the particular part of the disk is displayed on a display screen while stacking up the information in regard to a plurality of disks.

11. The disk surface inspection method according to claim 10, wherein:
the number of disks for which the information on the defects should be stacked up is specified on the display screen, and
the information on the defects is displayed on the display screen while stacking up the information in regard to the specified number of disks.

12. The disk surface inspection method according to claim 10, wherein the information on the defects on first and second sides of each disk is displayed side by side on the display screen while stacking up the information in regard to a plurality of disks.

13. A disk surface inspection method comprising the steps of:
extracting a disk from a cassette and mounting the disk on a first spindle with a first side of the disk facing upward;
irradiating the first side of the disk mounted on the first spindle with light and condensing and detecting reflected light from the irradiated first side of the disk while moving the first spindle in an axial direction and driving and rotating the first spindle along with detecting the rotation angle of the first spindle;
detecting defects on the first side of the disk by processing a signal generated by the condensation and the detection of the reflected light from the first side of the disk;
removing the disk from the first spindle, inverting and conveying the disk, and mounting the disk on a second spindle with a second side of the disk facing upward;
irradiating the second side of the disk mounted on the second spindle with light and condensing and detecting reflected light from the irradiated second side of the disk while moving the second spindle in an axial direction and driving and rotating the second spindle along with detecting the rotation angle of the second spindle;
detecting defects on the second side of the disk by processing a signal generated by the condensation and the detection of the reflected light from the second side of the disk; and
outputting the result of the detection of the defects on the first side of the disk and the result of the detection of the defects on the second side of the disk, wherein:
in the processing of the signal generated by the detection of the reflected light from the first side of the disk, the position of each of the detected defects is stored after converting the position into positional information with reference to the position of a particular part of the disk by use of rotation angle information on the first spindle acquired from a signal generated by detecting the rotation angle of the first spindle and positional information on a particular part of the disk stored in the cassette, and
in the processing of the signal generated by the detection of the reflected light from the second side of the disk, the position of each of the detected defects is stored after converting the position into positional information with reference to the position of a particular part of the disk by use of rotation angle information on the second spindle and positional information on a particular part of the disk just before being removed from the first spindle.

14. The disk surface inspection method according to claim 13, wherein the information on the defects detected and stored after the conversion into the positional information with reference to the position of the particular part of the disk is displayed on a display screen while stacking up the information in regard to a plurality of disks.

15. The disk surface inspection method according to claim 14, wherein
the number of disks for which the information on the defects should be stacked up is specified on the display screen, and
the information on the defects is displayed on the display screen while stacking up the information in regard to the specified number of disks.

16. The disk surface inspection method according to claim 14, wherein the information on the defects on first and second sides of each disk is displayed side by side on the display screen while stacking up the information in regard to a plurality of disks.
